(19) United States
(12) Patent Application Publication
(10) Pub. No.: US 2014/0093324 A1
(43) Pub. Date: Apr. 3, 2014

(54) Blind Rivet and Fastening Method Thereof

(71) Applicant: Takanori MAKINO, Toyohashi-shi (JP)

(72) Inventor: Takanori MAKINO, Toyohashi-shi (JP)

(73) Assignee: NEWFREY LLC, Newark, DE (US)

(21) Appl. No.: 13/416,470

(22) Filed: Mar. 9, 2012

(30) Foreign Application Priority Data
Mar. 10, 2011 (JP) 2011-52372

(51) Int. Cl. F16B 19/10

(52) U.S. Cl. CPC F16B 19/1063
USPC 411/43; 29/525.06

(57) ABSTRACT

A blind rivet comprises a sleeve, a body, and a mandrel. The sleeve includes a barrel with a hexagonal cross-section, a flange, and a through-hole. The rivet body includes a base, a barrel with slits extending in the axial direction, and a through-hole. The mandrel includes an elongated stem and a head. During the setting process, the barrel of the rivet body is pushed open by the head of the mandrel, and the objects to be fastened are fastened between the opened portion of the barrel and the flange of the sleeve. The mandrel is then pulled further and the polygonal vertices of the sleeve barrel are compressed by a round squeezing hole in a nosepiece. The compression of the sleeve barrel forces the inner circumference of the barrel into non-sliding engagement with the mandrel.

### CROSS-REFERENCE TO RELATED APPLICATIONS

This application claims priority from Japanese Patent Application No. 2011-052372, filed on Mar. 10, 2011, the disclosure of which is incorporated herein by reference.

### BACKGROUND OF THE INVENTION

The present invention relates to a blind rivet. The present invention relates more specifically to a blind rivet and fastening method thereof in which the shear strength between the sleeve and the mandrel is high without increasing the load used to squeeze the sleeve in a squeezed rivet-type blind rivet.

In well-known blind rivets, there is a hollow metal rivet having a rivet barrel and a flange on one end of the rivet barrel, and an enveloped metal mandrel in which a stem extends through the rivet and from the flange of the rivet barrel. A blind rivet has the advantage of being able to fasten a plurality of panels using an operation performed on one side.

A blind rivet is a rivet with two separate components: a sleeve with a flange, and a rivet body. A slit is formed in the rivet body in the axial direction, and the portions of the rivet body separated by the slit are pushed outward by the mandrel and fastened.

In such a blind rivet, the through-hole in the sleeve is aligned with the through-hole in the rivet body, the stem of the mandrel is inserted into the aligned through-holes in the sleeve and the rivet body, the head of the mandrel is arranged near the end of the rivet body, and the blind rivet is assembled so that the stem of the mandrel extends from the rivet body and the sleeve.

When members to be fastened are fastened using a blind rivet, the stem of the mandrel in the assembled blind rivet is inserted into the nosepiece of a fastening machine until the barrel of the sleeve comes into contact with the nosepiece. With the stem held by a gripping member, the head of the mandrel is inserted into a mounting hole of a member to be fastened such as a panel, and the flange on the sleeve is brought into contact with the portion of the member to be fastened surrounding the mounting hole. Next, when the fastening machine pulls strongly on the stem of the mandrel from the barrel side of the sleeve, the barrel of the rivet body is deformed so that it is folded, bent and opened by the edge of the mounting hole in the member to be fastened. The barrel of the sleeve is squeezed by the fastening machine, and engaged by the engaging portions of the mandrel in the through-hole of the sleeve. The mandrel is broken off at the slender breakable portion of the stem, and the members to be fastened such as panels can be fastened between the flange of the sleeve and the opened barrel of the rivet body.

After the blind rivet has been fastened, the squeezed barrel of the sleeve and the engaging portions of the mandrel in the through-hole of the sleeve have to be secured strongly so that they do not easily come off. In a blind rivet with a sleeve, the sleeve is squeezed and the shear strength is increased where the engaging portions of the mandrel engage the threading. In order to do so, the diameter of the sleeve barrel is enlarged and the amount of squeezing increased or the length is extended. When the diameter or length of the sleeve barrel is increased, the load needed to squeeze the sleeve barrel is increased when the blind rivet is fastened. Thus, the shear load on the breakable portion of the mandrel has to be increased. However, when the shear load on the breakable portion of the mandrel is increased, the extraction strength of the fastening machine has to be increased, and larger machinery is required. It also becomes more difficult to stably fasten the blind rivet.

Therefore, it would be desirable if an increase in the sleeve squeezing load could be prevented even when the shear strength between the sleeve and the mandrel is increased.

Patent Document 1 relates to a blind rivet which is easy to fasten from below while facing the ceiling of a building. In the blind rivet of Patent Document 1, a suspended member is arranged between an expandable portion for caulking a member and the enlarged head of a tensile rod so as to cooperate with the head of the sleeve body. When the suspended member is inserted elastically into a mounting hole in the member, it is restored and keeps the rivet body from falling out.

Patent Document 2 relates to a blind rivet that is easy to remove after fastening. The blind rivet in Patent Document 2 includes a rivet body having a trunk and a rivet head on one end of the trunk, a plug having a stem tail, an easy-to-bend connecting portion, and a spiral-shaped groove, and a stem having an end head. When the blind rivet is fastened, the material from the rivet head enters the spiral-shaped groove and is fastened. The fastened rivet can be released fairly easily by rotating the rivet head.

In Patent Document 1, the purpose of the invention is to keep the rivet body of a blind rivet from falling out. In Patent Document 2, the purpose of the invention is to allow a blind rivet to be easily removed after fastening. Neither one mentions reducing the load used to squeeze the sleeve of the blind rivet.

Therefore, it would be desirable if an increase in the sleeve squeezing load could be prevented even when the shear strength between the sleeve and the mandrel is increased.
[Patent Document 1] Published Unexamined Patent Application No. 2000-213516
[Patent Document 2] Published Unexamined Patent Application No. 63-254212

### SUMMARY OF THE APPLICATION

Therefore, a purpose of the present invention is to realize a blind rivet in which the shear strength between the sleeve and the mandrel is increased and the sleeve squeezing load is not increased by partially squeezing the sleeve deeply.

In order to achieve this purpose, in a first aspect of the present invention, the cross-section of the barrel of the sleeve has a hexagonal shape before fastening. The cross-section of the squeezing hole for squeezing the barrel of the sleeve in the fastening machine has a round shape, and the inner diameter of the squeezing hole becomes somewhat smaller so as to be shorter than the distance between vertices with respect to the barrel of the sleeve with a hexagonally shaped cross-section and to be substantially equal to the distance between opposing sides of the hexagonal shape. When a barrel of a sleeve with this shape is combined with the squeezing hole and the barrel of the sleeve is squeezed, the barrel of the sleeve is squeezed only in the vicinity of the vertices of the hexagonal shape. The vicinity of the central portion of the sides of the hexagonal shape is hardly squeezed at all. This reduces the sleeve-squeezing load to that which is necessary for squeezing. As a result, the shear strength between the sleeve and the mandrel can be increased without increasing the sleeve-squeezing load, even though the amount of sleeve being squeezed is partially increased.

A first aspect of the present invention is a blind rivet for fastening a plurality of members to be fastened having a mounting hole, characterized in comprising:

a sleeve having a barrel, a flange formed on one end of the barrel, and a through-hole formed so as to pass through the interior,

a rivet body having a through-hole formed so as to pass through the interior, and

a mandrel having an elongated stem, and a head having an outer diameter greater than the inner diameter of the through-holes in the sleeve and the rivet body,

the various components being combined so the head of the mandrel is arranged near the end of the rivet body, and the stem of the mandrel passes through the through-holes in the rivet body and the sleeve and extends from the end of the sleeve;

wherein the blind rivet is inserted from the head of the mandrel into through-holes in the members to be fastened, the surface of the flange in the sleeve makes contact with the portion of a member to be fastened surrounding the mounting hole,

the barrel of the sleeve contacts the entrance to a squeezing hole in a nosepiece having a different cross-sectional shape from the outer shape of the barrel of the sleeve, the rivet body is pushed and deformed by the head of the mandrel when the stem of the mandrel is pulled, the barrel of the sleeve is pulled into the squeezing hole, the cross-section of the barrel of the sleeve is squeezed by the shape of the squeezing hole, and the inner diameter of the inner circumference of the through-hole in the barrel of the sleeve becomes smaller and engages the engaging portions of the mandrel, and

the members to be fastened becoming fastened between the deformed rivet body and the flange of the sleeve.

When a sleeve is squeezed by a squeezing hole in the nosepiece having a different cross-sectional shape from the barrel of the sleeve, the squeezing area is smaller and the sleeve-squeezing load is smaller than a case in which the same thickness is squeezed around the entire periphery.

Optionally, the rivet body has a base, and a barrel formed at an end of the base having a slit extending in the axial direction, and the barrel of the rivet body is pushed by the head of the mandrel to open the barrel at the position contacting the edge of the mounting hole in a member to be fastened, and the members to be fastened are fastened between the opened portion of the barrel in the rivet body and the flange in the sleeve.

Because the slit makes the rivet body easier to open, the members to be fastened can be fastened stably.

Preferably, the mandrel is broken off in the breakable portion of the stem with a small diameter, and the section from the breakable portion to the head remains in the fastened section when the members to be fastened are fastened.

Optionally, the cross-section of the barrel in the sleeve has a hexagonal shape, the cross-section of the squeezing hole in the nosepiece has a round shape, and the cross-section of the barrel in the sleeve is squeezed into a round shape.

Optionally, the cross-section of the barrel in the sleeve has a round shape, the cross-section of the squeezing hole in the nosepiece has a polygonal shape, and the cross-section of the barrel in the sleeve is squeezed into a polygonal shape.

Optionally, the polygonal shape is a hexagonal shape.

Optionally, the cross-section of the barrel in the sleeve has a round shape, the cross-section of the squeezing hole in the nosepiece has a round shape with protrusions at equal intervals in the circumferential direction, and the cross-section of the barrel in the sleeve is squeezed into a round shape with recesses at equal intervals in the circumferential direction.

A second aspect of the present invention is a blind rivet for fastening a plurality of members to be fastened having a mounting hole, characterized in comprising:

a sleeve having a barrel with a cross-section having a polygonal shape, a flange formed on one end of the barrel, and a through-hole formed so as to pass through the interior;

a rivet body having a through-hole formed so as to pass through the interior; and

a mandrel having an elongated stem, and a head having an outer diameter greater than the inner diameter of the through-holes in the sleeve and the rivet body;

the various components being combined so the head of the mandrel is arranged near the end of the rivet body, and the stem of the mandrel passes through the through-holes in the sleeve and the rivet body and extends from the end of the sleeve.

When the stem of the mandrel is pulled while the barrel of the sleeve in the blind rivet is being squeezed by the through-hole in the nosepiece having a cross-section with a round shape, the cross-section of the barrel of the sleeve is squeezed into a round shape, and the blind rivet is fastened.

A third aspect of the present invention is a method for fastening members to be fastened using a blind rivet, characterizing in comprising the steps of:

preparing a sleeve having a barrel with a polygonal cross-section, a flange formed on one end of the barrel, and a through-hole formed so as to pass through the interior,

a rivet body having a base, a barrel formed at an end of the base having a slit extending in the axial direction, and a through-hole formed so as to pass through the interior, and

a mandrel having an elongated stem, and a head having an outer diameter greater than the inner diameter of the through-holes in the sleeve and the rivet body;

combining the various components so the head of the mandrel is arranged near the barrel-side end of the rivet body, the stem of the mandrel passes through the through-holes in the sleeve and the rivet body and extends from the barrel-side end of the sleeve, and a blind rivet is prepared;

inserting the blind rivet from the head of the mandrel into through-holes in the members to be fastened, the surface of the flange-side end of the sleeve contacting the portion of a member to be fastened surrounding the mounting hole;

bringing the barrel-side end of the sleeve into contact with the entrance to a squeezing hole having a round cross-section in the nosepiece of a fastening machine; and

pulling the stem of the mandrel from the barrel side of the sleeve so that the barrel of the rivet body is pushed by the head of the mandrel to open the barrel at the position contacting the edge of the mounting hole in a member to be fastened, the members to be fastened are fastened between the opened portion of the barrel in the rivet body and the flange in the sleeve,

the barrel in the sleeve is squeezed by the squeezing hole in the nosepiece, the outer diameter at the vertices of the barrel with a polygonal shape is reduced, the inner circumference of the through-hole in the barrel engages the engaging portion of the mandrel, and

the mandrel is broken off in the breakable portion of the stem with a small diameter.

Thus, in the present invention, a blind rivet can be obtained in which the sleeve squeezing load is not increased, and in which the shear strength between the sleeve and the mandrel is high.

### BRIEF DESCRIPTION OF THE SEVERAL VIEWS OF THE DRAWING

FIG. 1 is a partially cutaway front view of the blind rivet in a first embodiment of the present invention.

FIG. 2 (a) is a partially cutaway front view of the sleeve of the blind rivet in FIG. 1, and FIG. 2 (b) is a right side view of the same.

FIG. 3 (a) is a partially cutaway front view of the rivet body of the blind rivet in FIG. 1, and FIG. 3 (b) is a right side view of the same.

FIG. 4 is a front view of the mandrel of the blind rivet in FIG. 1.

FIG. 5 (a) is an enlarged view of section A of the mandrel in FIG. 4, and FIG. 5 (b) is an enlarged view of section B of the same.

FIG. 6 is a partially cutaway front view of the blind rivet in FIG. 1 inserted into holes in members to be fastened.

FIG. 7 is a partially cutaway front view of the step in which the blind rivet in FIG. 1 is set in the fastening machine used to fasten the members to be fastened.

FIG. 8 is a partially cutaway front view of the step in which members to be fastened are fastened by the blind rivet in FIG. 1.

FIG. 9 is a partially cutaway front view of the members fastened by the blind rivet in FIG. 1.

FIG. 10 is a right side view of the sleeve when the members have been fastened by the blind rivet in FIG. 9.

FIG. 11 is a right side view of the sleeve when members have been fastened by the blind rivet in a second embodiment of the present invention.

FIG. 12 is a right side view of the sleeve when members have been fastened by the blind rivet in a third embodiment of the present invention.

### DETAILED DESCRIPTION OF THE PREFERRED EMBODIMENTS

The following is an explanation of the blind rivets in embodiments of the present invention with reference to the figures.

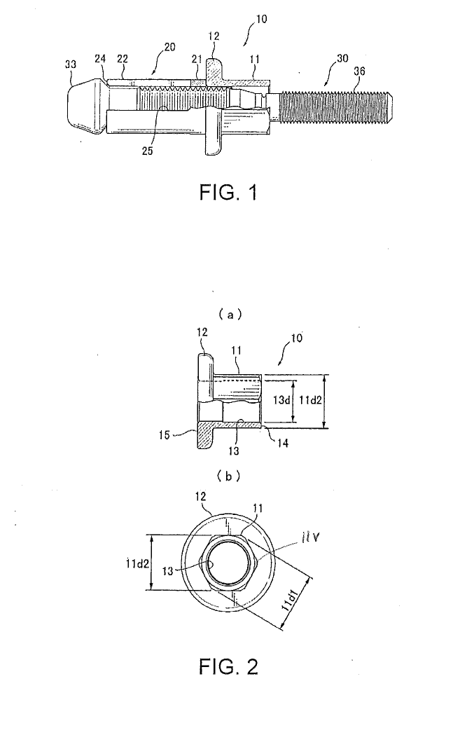

FIG. 1 is a partially cutaway front view of the blind rivet in a first embodiment of the present invention. This blind rivet includes a sleeve 10, a rivet body 20, and a mandrel 30. The through-hole in the rivet body 20 is aligned with the through-hole in the sleeve 10, the stem of the mandrel 30 is inserted into the aligned through-holes, and the head 33 of the mandrel 30 is arranged near the slitted end 24 of the rivet body 20.

The following is an explanation of the sleeve 10, rivet body 20, and mandrel 30 constituting the blind rivet with reference to FIG. 2 through FIG. 4.

FIG. 2 (a) is a partially cutaway front view of the sleeve 10, which is a component of the blind rivet in this embodiment of the present invention, and FIG. 2 (b) is a right side view of the same. The sleeve 10 includes a cylindrical barrel 11, and a flange 12 formed at one end of the barrel 11 and having a larger diameter than the barrel 11. The cross-sectional outer shape of the barrel 11 is a hexagonal shape, and the end with the barrel 11 is the barrel-side end 14. The outer shape of the flange 12 is a round shape, and an end with the flange 12 is the flange-side end 15. The outer diameter of the flange can have a hexagonal shape.

A through-hole (bore) 13 with a round cross-section extends between the barrel-side end 14 and the flange-side end 15 of the sleeve 10. The inner diameter 13d of the through-hole 13 is large enough to allow insertion of the stem 31 of the mandrel 30, but is smaller than the outer diameter 33d of the head 33 of the mandrel 30.

The sleeve 10 is made out of a softer material than the mandrel 30 such as aluminum or an aluminum alloy. Alternatively, it can be made out of the same material as the mandrel 30 such as steel.

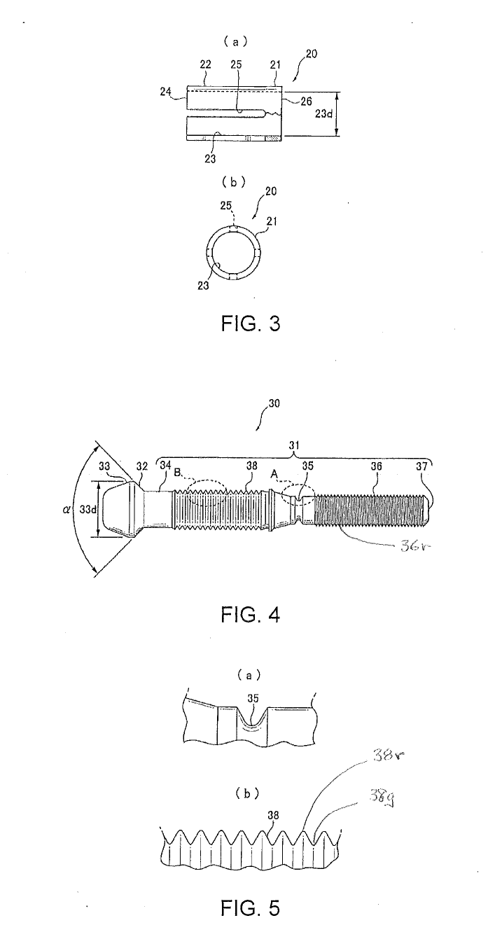

FIG. 3 (a) is a partially cutaway front view of the rivet body 20 of the blind rivet in FIG. 1, and FIG. 3 (b) is a right side view of the same.

The rivet body 20 has an overall round cylindrical shape and includes a round cylindrical base 21 and a barrel 22 continuing from the base 21. The end of the base 21 in the axial direction is the base end 26, and the end of the barrel 22 is the barrel-side end 24. Slits 25 are formed in the barrel 22 at equal intervals in the circumferential direction which extend to the barrel-side end 24 in the axial direction. There are four slits in this embodiment. A through-hole (bore) 23 which extends in the axial direction is formed inside the rivet body 20. The inner diameter 23d of the through-hole 23 is substantially equal to the inner diameter 13d of the through-hole 13 in the sleeve 10. The inner diameter is large enough for the stem 31 of the mandrel 30 to be inserted, but is smaller than the outer diameter 33d of the head 33 of the mandrel 30 so that the head 33 comes into contact with the barrel-side end 24 and stops.

FIG. 4 is a front view of the mandrel 30, which is a component of the blind rivet in this embodiment of the present invention. The mandrel 30 includes an elongated stem 31, and a head 33 at one end of the stem 31. The outer diameter 33d of the head 33 is larger than the inner diameter 13d of the through-hole 13 in the sleeve 10, and is larger than the inner diameter 23d of the through-hole 23 in the rivet body 20. The outer diameter 33d of the head 33 is smaller than the inner diameters 43d, 44d of the mounting holes 43, 44 in the members to be fastened 41, 42 so that the head can pass through the mounting holes 43, 44. The portion of the stem 31 continuing from the head 33 is a tapered portion 32 which is inclined so that the outer diameter becomes smaller on the stem 31 side. In this embodiment, the angle α forming the tapered portion is 90 degrees.

The stem 31 is column-shaped, and can be inserted into the through-hole 13 in the sleeve 10 and into the through-hole 23 in the rivet body 20. The length of the stem 31 is greater than the total length of the through-hole 13 in the sleeve 10 and the through-hole 23 in the rivet body 20. The stem 31 of the mandrel 30 is inserted into the through-hole 13 in the sleeve 10 and the through-hole 23 in the rivet body 20. When the head 33 is adjacent to the barrel-side end 24 of the rivet body 20, the tip 37 of the stem 31 protrudes from the barrel-side end 14 of the sleeve 10.

From the tapered portion 32 continuing after the head 33, the stem 31 of the mandrel 30 includes a column-shaped portion 34, an engaging portion 38, a breakable portion 35, a gripped portion 36, and a tip 37. The column-shaped portion 34 is adjacent to the tapered portion 32.

The engaging portion 38 is adjacent to the column-shaped portion 34. FIG. 5 (b) is an enlarged view of the engagement portion 38 of the mandrel 30 (Section B in FIG. 4). Circumferential grooves 38g are formed at a predetermined interval in the engaging portion 38, forming engagement ridges 38r between the grooves. When the blind rivet is fastened by a fastening machine, the barrel 11 of the sleeve 10 is pushed by the nosepiece of the fastening machine from the outer periphery, and its inner diameter becomes smaller. The engagement ridges 38r of the engaging portion 38 are pressed into and engage the inner circumference of the through-hole 13 when the barrel portion 11 of sleeve 10 is radially compressed and become secured so the mandrel 30 portion does not fall out of the sleeve 10. Screw-like threaded grooves can also be formed in the engaging portion 38.

The breakable portion 35 is adjacent to the engaging portion 38. FIG. 5 (a) is an enlarged view of the breakable portion 35 of the mandrel (Section A in FIG. 4). The outer diameter of the breakable portion 35 is smaller than the engaging portion 38 or the gripped portion 36, so that the stem breaks off at the breakable portion 35. When the blind rivet is assembled, the breakable portion 35 is received in the through-hole 13 of the sleeve 10. When the stem 31 of the mandrel 30 is pulled out by the fastening machine and a certain pulling force is exceeded, the stem breaks off at the breakable portion 35.

A gripped portion 36 with a diameter greater than that of the breakable portion 35 is adjacent to the breakable portion 35. Multiple levels of engagement grooves 36r are formed in the gripped portion 36 so that the gripping member of the fastening machine does not slip when gripping the gripped portion. The tip 37 is at the end of the stem 31.

The mandrel 30 can be made from a material such as steel.

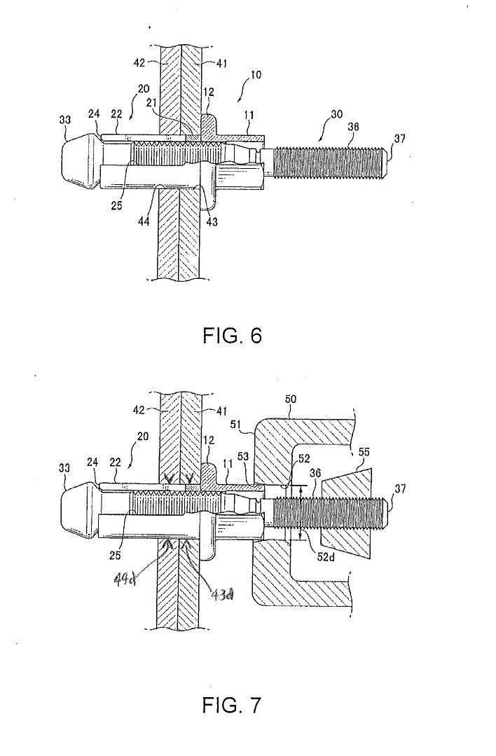

FIG. 6 is a partially cutaway front view of the blind rivet in FIG. 1 inserted into mounting holes 43, 44 in members to be fastened 41, 42. The left side of FIG. 6 is the blind side, and the blind rivet mounting operation is performed from the right.

The members to be fastened 41, 42 overlap so that the position of the mounting hole 43 in one member to be fastened 41 is aligned with the position of the mounting hole 44 in the other member to be fastened 42.

The blind rivet in FIG. 1 assembled from the sleeve 10, the rivet body 20, and the mandrel 30 is inserted into the mounting holes 43, 44 in the members to be fastened 41, 42 from the right in FIG. 6, and the flange 12 on the sleeve 10 is brought into contact with the surface of the member to be fastened 41 surrounding the mounting hole 43.

The following is an explanation with reference to FIG. 7 through FIG. 9 of the operation performed to fasten the members to be fastened 41, 42 using the blind rivet in this embodiment of the present invention.

FIG. 7 is a partially cutaway front view of the step in which the blind rivet in FIG. 6 is set in the fastening machine used to fasten the members to be fastened 41, 42. The nosepiece 50 of the fastening machine has an end face 51 on the blind rivet side, and the central portion has a squeezing hole 52 having a round cross-section. The inner diameter 52d of the squeezing hole 52 is slightly smaller than the distance 11d1 between the vertices of the hexagonally shaped barrel 11 in the sleeve 10, and is substantially equal to the distance 11d2 between the hexagonal sides of the barrel 11. An inclined portion (tapered bore) 53 is formed near the end face 51 of the squeezing hole 52. When the stem 31 of the mandrel 30 is inserted into the squeezing hole 52 of the nosepiece 50, the barrel-side end 14 of the sleeve 10 makes contact with the inner circumference of the inclined portion 53 of the nosepiece 50 and stops. The inner diameter 52d of the squeezing hole 52 can be slightly shorter than the distance 11d2 between the hexagonal sides of the barrel 11 in the sleeve 10 if the squeezing load is not increased.

Next, the gripped portion 36 of the mandrel 30 is gripped by the gripping member 55 and is pulled out (to the right in FIGS. 6 and 7). The tapered portion 32 of the mandrel 30 adjacent to the head 33 makes contact with the barrel-side end 24 of the rivet body 20. By gripping the gripped portion 36 of the mandrel 30 and pulling out, the tapered portion 32 folds, bends, and opens the slit 25 portions of barrel 22 at the position where the barrel 22 of the rivet body 20 makes contact with the edge of the mounting hole 44 in the member to be fastened 42.

The nosepiece 50 moves to the left in FIG. 7 relative to the sleeve 10. Thus, the barrel 11 of the sleeve 10 is squeezed and radially compressed around engaging part 38 by the inclined surface 53 and squeezing hole 52 in the nosepiece 50 of the fastening machine.

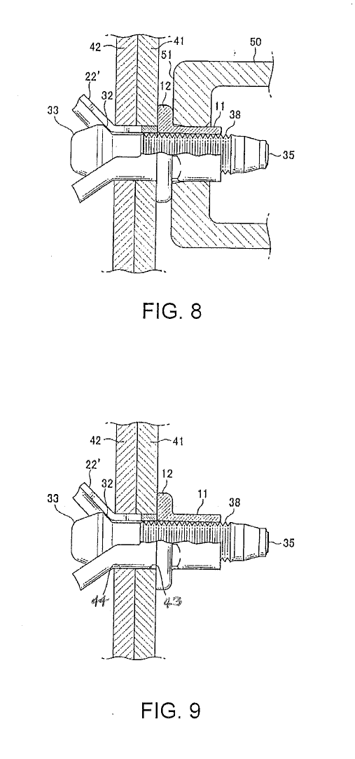

FIG. 8 is a partially cutaway front view of the step in which the gripped portion 36 of the mandrel 30 is pulled out, and the members to be fastened 41, 42 are fastened by the blind rivet. While the barrel 11 with the flange 10 is being pulled from the outer circumference, the squeezing hole 52 in the nosepiece 50 deforms the six vertices 11v of the hexagonally shaped barrel 11 so that the distance 11d1 between the vertices becomes smaller and the reduced distance 11d1′ between the deformed vertices becomes substantially equal to the inner diameter 52d of the squeezing hole 52. The smaller distance 11d1′ between the vertices is substantially equal to the distance 11d2 between the sides of the hexagon. As can be seen in a comparison of the barrels 11 in FIG. 7 and FIG. 8, the outer diameter of the barrel 11 after deformation by the squeezing hole 52 has no hexagonal vertices and is substantially round shaped.

At this time, by squeezing the outer circumference of the barrel 11, the diameter of the inner circumference of the through-hole 13 becomes radially compressed and smaller than the inner diameter 13d before fastening, and the inner surface of through-hole 13 deforms and engages the engagement ridges 38r in the engaging portion 38 of the mandrel 30.

When the end face 51 comes into contact with the flange 12 of the sleeve 10, the nosepiece 50 stops.

The blind rivet clamps the members to be fastened 41, 42 between the opened barrel 22′ in the rivet body 20 and the flange 12 in the sleeve 10. Afterwards, when the mandrel 30 is pulled out strongly, it breaks off at the breakable portion 35, and the fastened section of the mandrel from the breakable portion 35 to the head 33 remains inside rivet body 20 and sleeve 10. Because the inner surface of compressed through-hole 13 in the sleeve 10 engages the engaging portion 38 of the mandrel 30, the section of the mandrel 30 remaining in the blind rivet does not fall out of the blind rivet. Because the remaining section of the mandrel 30 is securely fixed to the barrel 11 in the sleeve 10, high fastening strength can be obtained. Afterwards, the nosepiece 50 is withdrawn to the right in FIG. 8, and the fastening is completed.

FIG. 9 is a front view of the members to be fastened 41 and 42 after fastening by the blind rivet in FIG. 8. In this figure, a portion of the rivet is cut away. The members to be fastened 41, 42 are fastened between the opened barrel 22′ of the rivet body 20 and the flange 12 of the sleeve 10.

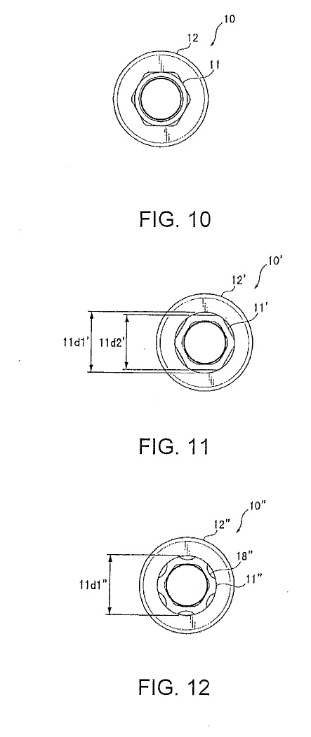

FIG. 10 is a right side view of the sleeve 10 when the members to be fastened have been fastened by the blind rivet in FIG. 9. In FIG. 10, the rivet body 20 and the mandrel 30 are not shown. In the barrel 11 of the sleeve 10, the hexagonal vertices are deformed by the hole 52 in the nosepiece 50, and the barrel becomes substantially round shaped. Because the outlet to the squeezing hole 52 in the nosepiece 50 has an inclined portion 53, the portion of the barrel 11 adjacent to the flange 12 has uncrushed vertices and retains its hexagonal shape.

FIG. 11 is a right side view of the sleeve 10′ when members to be fastened 41, 42 have been fastened by the blind rivet in a second embodiment of the present invention. In FIG. 11, the rivet body 20 and the mandrel 30 are not shown. In the first embodiment, the cross-section of the barrel 11 in the sleeve 10 is hexagonally shaped, and barrel 11 is squeezed by a squeezing hole with a round-shaped cross-section. In the second embodiment, the cross-section of the barrel 11′ in the sleeve 10′ is round shaped before the fastening operation, and the cross-section of the squeezing hole 52′ in the nosepiece 50′ of the fastening machine is hexagonally shaped. A barrel 11′ with a round-shaped cross-section is squeezed by a squeezing hole 52′ with a hexagonally shaped cross-section to produce a barrel 11′ with a round-shaped cross-section. The distance 11d1′ between opposing vertices of the hexagonal shape after squeezing is nearly equal to the diameter of the barrel 11′ before squeezing, and the distance 11d2′ between the opposing sides of the hexagonal shape is smaller than the diameter of the barrel 11′ before squeezing. The opposing sides of the hexagonal shape after squeezing have been squeezed, but the vertices of the hexagon shape have hardly been squeezed at all. This reduces the sleeve squeezing load.

FIG. 12 is a right side view of the sleeve 10″ when members to be fastened 41, 42 have been fastened by the blind rivet in a third embodiment of the present invention. In FIG. 12, the rivet body 20 and the mandrel 30 are not shown. In the third embodiment, the cross-section of the barrel 11″ in the sleeve 10″ before fastening is round shaped just as in the second embodiment. In the third embodiment, the cross-section of the squeezing hole 52″ in the nosepiece 50′ has six protrusions formed circumferentially at equal intervals. When a barrel 11″ with a round-shaped cross-section is squeezed by a squeezing hole 52″ with this shape, recesses 18″ are formed at six locations in the cross-section of the barrel 11″. The diameter 11d1″ outside of the recesses 18″ is substantially equal to the diameter of the sleeve 11′ before squeezing. Because the portions outside of the recesses 18″ are hardly squeezed at all, the sleeve squeezing load is reduced.

In the first through third embodiments of the present invention, a blind rivet can be obtained in which the sleeve squeezing load is not increased, and in which the shear strength between the sleeve and the mandrel is high.

It will be appreciated by persons skilled in the art that the above embodiments have been described by way of example only, and not in any limitative sense, and that various alterations and modifications are possible without departure from the scope of the invention as defined by the appended claims.

What is claimed is:

1. A combination of a blind rivet and a rivet setting tool, the blind rivet comprising:
a sleeve including a tubular barrel defining an axial through hole with a first inner diameter and a radial flange formed on a first end of the barrel and a second end opposite to the first end, and the barrel has an exterior surface with a first cross sectional shape,
a tubular rivet body defining an axial bore of a second inner diameter and including a body first end and a body second end,
a mandrel including an elongated stem and a head located at a stem first end opposite to a stem second end including a tip, the head having an outer diameter greater than the second inner diameter of the rivet body, and
the mandrel is located coaxially within the body and sleeve, with the stem slidably arranged in the bore of the body and the through hole of the sleeve with the head adjacent to the body first end, and the body second end is adjacent to the sleeve first end, and the stem second end projects from the sleeve second end;
and the rivet setting tool comprises:
a gripping member for holding and axially pulling the stem second end; and
a nosepiece defining an axial squeezing hole for compressing the sleeve barrel during a rivet setting operation, and the nosepiece defining the squeezing hole as a second cross sectional shape different from the first cross section shape of the barrel of the rivet sleeve

2. A combination of a blind rivet and a rivet setting tool according to claim 1, wherein the rivet body includes a plurality of slits, each slit extending radially through the barrel into the bore and extending axially from an open end at the body first end to a closed end opposite to the open end.

3. A combination of a blind rivet and a rivet setting tool according to claim 2, wherein the mandrel includes an engaging portion proximate to the stem first end and a gripping portion proximate to the stem second end, and a breakable portion of a reduced diameter located between the engaging portion and the gripping portion.

4. A combination of a blind rivet and a rivet setting tool according to claim 1, wherein the first cross-sectional shape of the sleeve barrel is a polygonal shape with a first maximum diameter, and the cross-section of the squeezing hole in the tool nosepiece is a round shape with a second maximum diameter less than the first maximum diameter.

5. A combination of a blind rivet and a rivet setting tool according to claim 4, wherein the polygonal shape is a hexagonal shape.

6. A combination of a blind rivet and a rivet setting tool according to claim 1, wherein the cross-section of the sleeve barrel is a round shape with a first maximum diameter, and the cross-section of the squeezing hole in the tool nosepiece is has a round shape with radially inward protrusions arranged circumferentially at equal intervals, and the protrusions define a second minimum diameter less than the first maximum diameter of the sleeve barrel.

7. A blind rivet for fastening a plurality of work pieces, the blind rivet comprising:
a sleeve including a barrel with an external cross-section of polygonal shape and defining an axial through hole, and a radial flange formed on barrel first end of and a barrel second end opposite to the barrel first end;
a tubular rivet body defining an axial bore of a second inner diameter and including a body first end and a body second end,
a mandrel including an elongated stem and a head located at a stem first end opposite to a stem second end including a tip, the head having an outer diameter greater than the second inner diameter of the rivet body, and
the mandrel is located coaxially within the body and sleeve, with the stem slidably arranged in the bore of the body and the through hole of the sleeve with the head adjacent to the body first end, and the body second end is adjacent to the sleeve first end, and the stem second end projects from the sleeve second end.

8. A method for fastening a plurality of work pieces using a blind rivet, the method comprising the steps of:
providing a blind rivet comprising:
a sleeve including a tubular barrel defining an axial through hole with a first inner diameter and a radial flange formed on a first end of the barrel and a second end opposite to the first end, and the barrel has an exterior surface with a polygonal cross section,
a tubular rivet body defining an axial bore of a second inner diameter and including a body first end and a body second end,
a mandrel including an elongated stem and a head located at a stem first end opposite to a stem second end including a tip, the head having an outer diameter greater than the second inner diameter of the rivet body, and
the mandrel is located coaxially within the body and sleeve, with the stem slidably arranged in the bore of the body and the through hole of the sleeve with the head adjacent to the body first end, and the body second end is adjacent to the sleeve first end, and the stem second end projects from the sleeve second end;
providing a rivet setting tool comprising:
a gripping member for holding and axially pulling the stem second end; and
a nosepiece defining an axial squeezing hole for compressing the sleeve barrel during a rivet setting operation, and the nosepiece defining the squeezing hole as a round cross sectional shape;
forming aligned holes through the work pieces to be joined;
inserting the head of the blind rivet through the holes in the work pieces until the sleeve flange is adjacent a surface of a first work piece;
grasping a portion of the mandrel stem adjacent the stem second end with the setting tool gripping member;
pulling the mandrel stem with the tool's gripping member so that the mandrel head is pulled into the body bore and causes the body barrel to deform radially outward and axially backward against a second work piece and thereby compress the work pieces between the deformed body and the sleeve flange;
drawing the sleeve second end into the squeezing hole of the setting tool nosepiece;
compressing the polygonal sleeve barrel within the round squeezing hole such that the sleeve through hole engages the mandrel stem and the stem is no longer slidable within the sleeve; and
breaking off the portion of the mandrel stem grasped by the setting tool.
